(19) United States
(12) Patent Application Publication
(10) Pub. No.: US 2006/0017316 A1
(43) Pub. Date: Jan. 26, 2006

(54) Light rim wheel

(76) Inventors: Flavio Rodrigues, Limeira (BR); Fernando Toshihiko Mitsuyassu, Limeira (BR); Nelson Gosser JR., Piracicaba (BR)

Correspondence Address: CARLSON, GASKEY & OLDS, P.C., 400 WEST MAPLE ROAD, SUITE 350, BIRMINGHAM, MI, 48009, US

(21) Appl. No.: 10/898,450

(22) Filed: Jul. 23, 2004

(51) Int. Cl. B60B 25/00

(52) U.S. Cl. 301/95.101

(57) ABSTRACT

A rim for a vehicle wheel includes a circular band defining an outer circumferential surface. A plurality of discrete openings is formed within the outer circumferential surface to reduce the weight of the rim. A lightweight sealing member is used to seal the discrete openings.

### TECHNICAL FIELD

The subject invention relates to a rim for a vehicle wheel that includes a plurality of openings formed within an outer circumferential surface of the rim to reduce weight.

### BACKGROUND OF THE INVENTION

A vehicle wheel includes a rim that is mounted for rotation with a rotating wheel component such as a wheel hub, for example. A tire is sealed against the rim. Traditionally, a rim is formed as a generally circular band with outwardly extending flanges formed around each edge of the circular band. The tire is sealed against the flanges and an outer surface of the circular band to form the vehicle wheel. Traditionally, the outer surface of the circular band is formed as a continuous unbroken surface to provide a good sealing interface for the tire.

The rim is typically made from a material such as steel, for example. This type of material is heavy, which increases the weight of the vehicle wheel. This increased weight adversely effects fuel economy.

It would be beneficial to provide a lighter rim for a vehicle wheel while still providing a good sealing interface for a tire, in addition to overcoming the other deficiencies in the prior art mentioned above.

### SUMMARY OF THE INVENTION

A wheel rim includes a generally circular band having an outer circumferential surface. A plurality of discrete openings is formed within the outer circumferential surface to reduce the weight of the wheel rim. A sealing member is used to cover the discrete openings.

In one example, the sealing member includes a liner that is wrapped around the outer circumferential surface to seal the discrete openings. In another example, the circular band is formed from a first material and the sealing member is formed from a second material that is less dense than the first material. The second material is used to fill the discrete openings.

In one disclosed embodiment, the discrete openings are formed as a plurality of holes that extend from the outer circumferential surface, through a thickness of the circular band, to an inner circumferential surface. The plurality of discrete openings is further formed as a first set of openings and a second set of openings. Each hole in the first set of openings is defined by a first cross-sectional area and each hole in the second set of openings is defined by a second cross-sectional area that is different than the first cross-sectional area.

The subject invention utilizes a plurality of discrete openings formed in a circular band of a wheel rim in combination with a sealing member, which covers the discrete openings, to provide a lightweight wheel rim. These and other features of the present invention can be best understood from the following specification and drawings, the following of which is a brief description.

### BRIEF DESCRIPTION OF THE DRAWINGS

FIG. 1 is a perspective view of a vehicle wheel rim incorporating the subject invention.

FIG. 2A is a cross-sectional front view, partially broken away, of the vehicle wheel rim of FIG. 1 including a lightweight liner covering a set of discrete openings.

FIG. 2B is a cross-sectional front view, partially broken away, of the vehicle wheel rim of FIG. 1 with a set of discrete openings filled with a lightweight material.

FIG. 3 is a perspective view, partially broken away, of one example of a set of discrete openings formed in a vehicle wheel rim.

FIG. 4 is a perspective view, partially broken away, of another example of a set of discrete openings formed in a vehicle wheel rim.

FIG. 5 is a perspective view, partially broken away, of another example of a set of discrete openings formed in a vehicle wheel rim.

### DETAILED DESCRIPTION OF THE PREFERRED EMBODIMENT

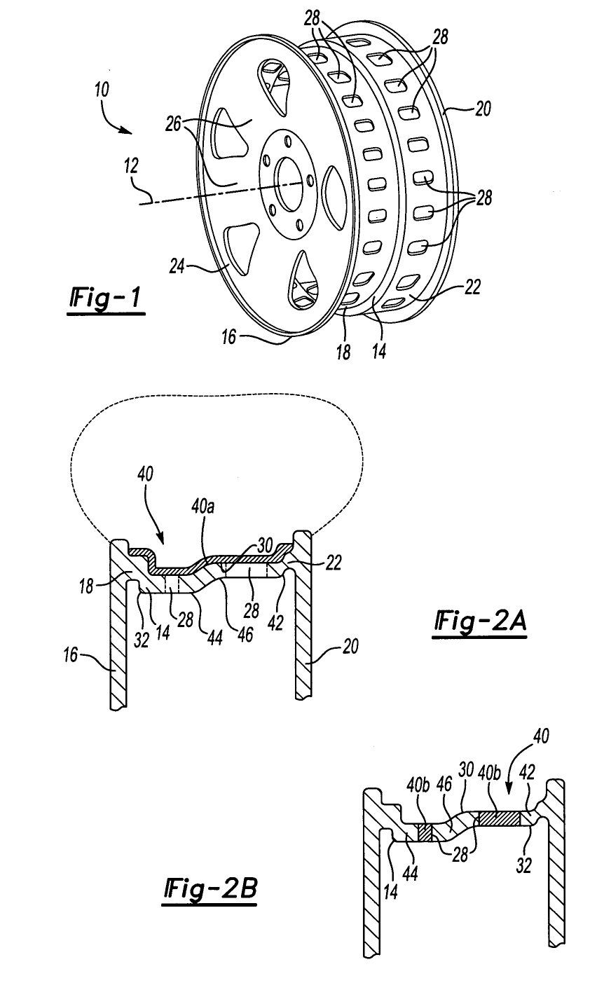

A vehicle wheel rim 10 is shown in FIG. 1. The vehicle wheel rim 10 is mounted to a rotating wheel structure (not shown) for rotation about an axis 12. The vehicle wheel rim 10 includes a generally circular band 14 with a first flange 16, positioned on an outboard edge 18 of the circular band 14, and a second flange 20 positioned on an inboard edge 22 of the circular band 14. A disc 24 including a plurality of spokes 26 is mounted to the circular band 14 around the outboard edge 18. A plurality of discrete openings 28 is formed within the circular band 14 to reduce the weight of the vehicle wheel rim 10. The discrete openings 28 can be formed in the circular band 14 by any method known in the art.

As shown in FIG. 2A, the circular band 14 has an outer circumferential surface 30 and an inner circumferential surface 32. Each discrete opening 28 is formed as a hole that extends through a thickness of the circular band 14 from the outer circumferential surface 30 to the inner circumferential surface 32. The discrete openings 28 are spaced radially apart from each other about the outer circumferential surface 30. The discrete openings 28 are also axially spaced apart from each other across a width of the circular band 14 in a direction parallel to the axis 12. As shown, the discrete openings 28 are generally equally spaced apart from each other about the outer circumferential surface 30, however, variable spacings could also be used.

A covering or sealing member 40 is used to cover the discrete openings 28 to provide a good sealing interface for a tire (indicated in phantom in FIG. 2A). The sealing member 40 can be a lightweight liner material 40a that is wrapped around the outer circumferential surface 30 of the circular band 14, as shown in FIG. 2A. Optionally, as shown in FIG. 2B, the sealing member 40 can be a lightweight material 40b that is used to individually fill or plug the discrete openings 28. Further, an overmolding operation or a plastic spray could be used to fill or cover the discrete openings 28. Another option would be to use a chemically reactive material that would expand to fill the discrete openings 28.

The vehicle wheel rim 10 is typically made from a material such as steel, for example, which is a heavy material. The discrete openings 28 are formed within the circular band 14 to reduce the overall weight of the vehicle wheel rim 10. The discrete openings 28 can be formed by stamping, casting, or any other known method in the art.

The discrete openings 28 are filled or covered with the sealing member 40, which is made from a material that is lighter or less dense than the vehicle wheel rim material. The sealing member 40 can be made from lightweight materials such as thermoplastic, Kevlar®, etc. The sealing member 40 can also include other materials such as carbon fibers, glass fibers, aluminum, and polymers. The discrete openings 28 can be filled or covered with this lightweight material in many different ways.

In the example of FIG. 2A, the lightweight liner material 40a is a mesh liner that is wrapped around the circular band 14 to cover the discrete openings 28. In the example of FIG. 2B, the lightweight material 40b plugs, or at least partially fills, the discrete openings 28. This can be done by an injection molding process or any other process known in the art.

The circular band 14 includes a first portion 42 defined by a first diameter, a second portion 44 defined by a second diameter that is less than the first diameter, and a third portion 46 defined by a varying diameter that transitions from the first portion 42 to the second portion 44. At least one discrete opening 28 is formed in each of the first 42 and second 44 portions. In the example shown, the third portion 46 has a continuous unbroken surface that separates the first 42 and second 44 portions. It should be understood that the third portion 46 could also include a desired number of discrete openings 28.

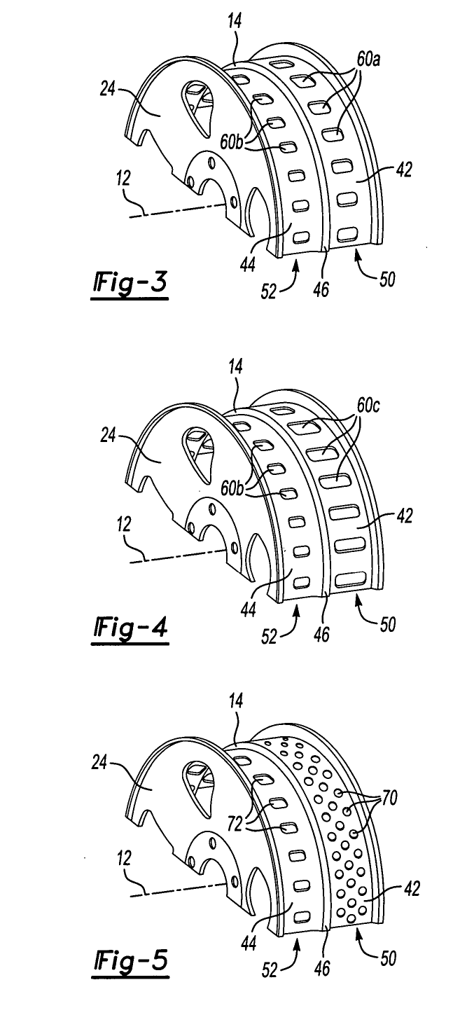

Examples of patterns of discrete openings 28 are shown in FIGS. 3-5. In each example, the plurality of discrete openings 28 includes a first set of openings 50 and a second set of openings 52. Each discrete opening 28 in the first set of openings 50 is defined by a first cross-sectional area and each discrete opening 28 in the second set of openings 52 is defined by a second cross-section area that is different than the first cross-sectional area. For example, the first set of openings 50 shown in FIG. 3 are larger than the second set of openings 52.

The first set of openings 50 is formed in the first portion 42 of the circular band 14 and the second set of openings 52 is formed in the second portion 44 of the circular band 14. The first set of openings 50 is axially spaced apart from the second set of openings 52 in a direction parallel to the axis 12. As discussed above, the third portion 46 of the circular band 14 provides a continuous unbroken surface that separates the first set of openings 50 from the second set of openings 52.

In FIG. 3, the first 50 and second 52 sets of openings 50 are formed as oval shaped slots where slots 60a in the first portion 42 are greater in size than slots 60b in the second portion 44. In FIG. 4, slots 60c are formed to have an even greater cross-sectional area than the slots 60a shown in the FIG. 3 configuration. In FIG. 5, the first set of openings 50 is formed as circular openings 70 and the second set of openings 52 is formed as oval shaped slots 72.

In each configuration, the plurality of discrete openings 28 defines a circumferential open area within the circular band 14. Preferably, a surface area defined by the outer circumferential surface 30 of the circular band 14 is greater than the circumferential open area. This ensures that the vehicle wheel rim 10 retains sufficient structure to support wheel input loads. However, depending upon the vehicle application, the surface area defined by the outer circumferential surface 30 of the circular band 14 could be less than the circumferential open area.

It should be understood that the configurations shown in FIGS. 3-5 are merely examples of different discrete opening embodiments. Many other configurations, with discrete openings 28 having different shapes and sizes in various combinations, could also be used. Further, it should be understood that the examples shown in FIGS. 3-5 also include a sealing member 40 as shown in FIG. 2A or 2B.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A wheel rim comprising:
a generally circular band having an outer circumferential surface;
a plurality of discrete openings formed within said outer circumferential surface; and
a sealing member covering said plurality of discrete openings.

2. The wheel rim according to claim 1 wherein each of said discrete openings comprises a hole extending through said circular band from said outer circumferential surface to an inner circumferential surface.

3. The wheel rim according to claim 2 wherein said plurality of discrete openings comprises a first set of holes and a second set of holes with each hole in said first set of holes having a first cross-sectional area and each hole in said second set of holes having a second cross-sectional area that is different than said first cross-sectional area.

4. The wheel rim according to claim 3 wherein said circular band includes a first portion defined by a first diameter, a second portion defined by a second diameter that is less than said first diameter, and a third portion defined by a varying diameter that transitions from said first portion to said second portion wherein said first set of holes is formed within said first portion and said second set of holes is formed within said second portion.

5. The wheel rim according to claim 4 wherein said third portion has a continuous unbroken surface that separates said first set of holes from said second set of holes.

6. The wheel rim according to claim 2 wherein each of said holes is generally equally spaced apart from an adjacent hole about said outer circumferential surface.

7. The wheel rim according to claim 2 wherein said holes are radially spaced apart from each other about said outer circumferential surface.

8. The wheel rim according to claim 1 wherein said circular band is formed from a first material and said sealing member is formed from a second material that is less dense than said first material wherein said sealing member at least partially fills each of said discrete openings.

9. The wheel rim according to claim 1 wherein said sealing member comprises a lining wrapped around said outer circumferential surface to cover said plurality of discrete openings.

10. A wheel rim comprising:
a generally circular band formed from a first material and having an outer circumferential surface; and
a plurality of discrete openings formed within said outer circumferential surface wherein said plurality of discrete openings is covered with a second material that is different than said first material.

11. The wheel rim according to claim 10 wherein said plurality of discrete openings defines a circumferential open area and wherein said outer circumferential surface has a greater surface area than said circumferential open area.

12. The wheel rim according to claim 10 wherein each of said discrete openings is at least partially filled with said second material and wherein said second material is less dense than said first material.

13. The wheel rim according to claim 10 wherein said second material comprises a liner wrapped around said outer circumferential surface to seal said plurality of discrete openings.

14. The wheel rim according to claim 10 wherein said plurality of discrete openings comprises a first set of first openings with each first opening having a first cross-sectional area and a second set of second openings with each second opening having a second cross-sectional area that is different than said first cross-sectional area.

15. The wheel rim according to claim 14 wherein said first set of openings is axially spaced apart from said second set of openings in a direction parallel to an axis of rotation defined by said circular band.

16. A method for making a lightweight wheel rim including a generally circular band made from a first material comprising the steps of:
(a) forming a plurality of discrete openings within an outer circumferential surface of the circular band; and
(b) covering the plurality of discrete openings with a second material that is different than the first material.

17. The method according to claim 16 wherein the second material is less dense than the first material and step (b) further includes sealing the discrete openings by filling the discrete openings with the second material.

18. The method according to claim 16 wherein step (b) further includes sealing the discrete openings by wrapping a liner about the outer circumferential surface to cover the plurality of discrete openings.

19. The method according to claim 16 wherein the plurality of discrete openings defines a circumferential open area and step (a) further includes forming the circular band with a greater surface area than the circumferential open area.

20. The method according to claim 16 wherein step (a) further includes forming the plurality of discrete openings as a first set of first openings with each first opening having a first cross-sectional area and a second set of second openings with each second opening having a second cross-sectional area that is different than the first cross-sectional area, and spacing the first set of openings apart from the second set of openings in a lateral direction extending generally parallel to an axis of rotation defined by the circular band.
